(19) United States
(12) Patent Application Publication
(10) Pub. No.: US 2025/0190746 A1
(43) Pub. Date: Jun. 12, 2025

(54) SYNCHRONIZED EXECUTION OF NEURAL NETWORK LAYERS IN MULTI-CORE ENVIRONMENTS

(71) Applicant: TEXAS INSTRUMENTS INCORPORATED, Dallas, TX (US)

(72) Inventors: Anand Pathak, Bangalore (IN); Anshu Jain, Bangalore (IN); Lakshay Gupta, Bangalore (IN); Pramod Swami, Bangalore (IN)

(21) Appl. No.: 18/747,784

(22) Filed: Jun. 19, 2024

(30) Foreign Application Priority Data
Dec. 7, 2023 (IN) 202341083675

(51) Int. Cl. G06N 3/04

(52) U.S. Cl. CPC G06N 3/04

(57) ABSTRACT

Disclosed herein are systems and methods for executing a neural network (NN) across multiple processing cores. In an example embodiment, a system includes processing circuitry comprising a first processing core and a second processing core, such that the second processing core is coupled to the first processing core. Prior to executing a current layer of the NN, the second processing core determines a synchronization status of the first processing core with respect to a previous layer of the NN. Next, the second processing core executes the current layer of the NN based on data computed by the first and second processing cores with respect to the previous layer of the NN. Upon executing the current layer of the NN, the second processing core updates the first processing core with a synchronization status of the second processing core with respect to the current layer of the NN.

### RELATED APPLICATIONS

This application is related to, and claims the benefit of priority to, India Provisional Patent Application No. 202341083675, filed on Dec. 7, 2023, and entitled “Multi-State Synchronization Methodology for Multi-Core DNN Processing”, which is hereby incorporated by reference in its entirety.

### TECHNICAL FIELD

Aspects of the disclosure are related to the field of computing hardware and software and more particularly to the synchronization of a neural network that is executed across multiple processing cores.

### BACKGROUND

A multi-core device represents a type of processing device which employs multiple processing cores to perform various functions. For example, such devices may include an integrated circuit (e.g., central processing unit (CPU)) comprising multiple digital signal processors (DSPs) configured to execute the layers of a neural network (NN).

Traditional methods for executing a neural network on a multi-core device aim to accelerate the processing times of the network by dividing the workload of each layer across the multiple processing cores. For example, each processing core of the multi-core device may receive a section of the input data to perform the operations of a layer of the network, such that the output data of each processing core may be combined to form the output data of the layer.

In some multi-core systems, each core of the multiple processing cores executes in parallel with the other processing cores, while in other systems, each core takes turns executing. In both cases, the multi-core device must ensure the execution of each layer of the NN is synchronized across the multiple processing cores. Meaning, the multi-core device ensures each core is executing the same layer of the neural network at the same time.

Current methods to synchronize the execution of a neural network across multiple processing cores rely on maintaining an execution state for each of the multiple processing cores. Problematically, these methods are limited to maintaining a single state for each layer of the network. As a result, current methods for synchronizing a neural network can lead to dead-lock conditions, where a first core of the multiple processing cores is permanently stuck executing a previous layer of the network, while the remaining cores are stuck waiting for the first core to finish execution of the previous layer.

### SUMMARY

Technology is disclosed herein for improving the execution of neural networks (NNs) employed across multiple processing cores. In one example embodiment, a system includes processing circuitry comprising a first processing core and a second processing core coupled to the first processing core. Prior to executing a current layer of the NN, the second processing core determines a synchronization status of the first processing core with respect to a previous layer of the NN. Next, the second processing core executes the current layer of the NN based on data computed by the second processing core and other data computed by the first processing core with respect to a previous layer of the network. Upon executing the current layer of the NN, the second processing core updates the first processing core with a synchronization status of the second processing core with respect to the current layer of the NN.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a synchronization method in an implementation.

FIG. 3 illustrates an operational sequence in an implementation.

FIGS. 4A-4C illustrate an operational scenario in an implementation.

FIG. 5 illustrates another system in an implementation.

FIG. 6 illustrates a synchronization process in an implementation.

FIG. 7 illustrates another operational scenario in an implementation.

FIG. 8 illustrates another operational scenario in an implementation.

FIG. 9 illustrates a software block diagram in an implementation.

FIG. 10 illustrates an operational example in an implementation.

FIG. 11 illustrates a computing system suitable for implementing the various operational environments, architectures, processes, scenarios, and sequences discussed below with respect to the other Figures.

### DETAILED DESCRIPTION

Technology is disclosed herein for synchronizing the execution of a neural network (NN) on a multi-core device. Multi-core devices are representative of devices which include multiple processing cores. For example, such devices may include a central processing unit (CPU), microcontroller unit (MCU), graphics processing unit (GPU), tensor processing unit (TPU), or another general-purpose processor (GPP) of the like which comprises multiple processing cores. A processing core is representative of a device configured to execute program instructions. For example, a processing core may be representative of a digital signal processor (DSP) configured to execute the layers of a neural network.

Generally, neural networks comprise a series of interconnected layers configured to perform a designated task. For example, such tasks may include image classification, image segmentation, object detection, or other computer vision tasks of the like. To execute a neural network on a multi-core device, the input data to each layer is divided up into sections, such that each section of data acts as an input to a respective processing core. Meaning, the workload of each layer is distributed across the various processing cores of the multi-core system. In an implementation, the number of input data sections is dependent on the number of processing cores in the multi-core system. For example, the input data will be divided into four sections for a system consisting of four processing cores.

During the course of operation, each processing core receives its section of the input data and in turn generates a section of output data. As a result, the output data of each processing core may be combined to generate the output data of a layer. Prior to executing a next layer of the network, the output data of the current layer must be divided into sections to provide input data for executing the next layer of the network. In addition, prior to executing the next layer of the network, the multi-core system must ensure each of the multiple processing cores is synchronized. Meaning, the multi-core system must ensure each of the multiple processing cores is finished executing the current layer of the network before executing the next layer of the network.

Existing techniques for synchronizing the execution of a neural network on a multi-core device are limited to maintaining a single synchronization status for each processing core of the network. For example, each processing core may store a synchronization status in memory, such that the synchronization statuses indicate which layer each processing core is currently executing. As a result, current synchronization methods can lead to dead-lock conditions where a first processing core is permanently stuck executing a previous layer of the network while the remaining processing cores idly wait for the first processing core to finish execution of the previous layer. In contrast, disclosed herein is a new technique for synchronizing the execution of a neural network on a multi-core device which utilizes multiple synchronization statuses for each processing core, and by design, avoids dead-lock conditions.

In one example embodiment, a system including processing circuitry comprising a first processing core and a second processing core coupled to the first processing core is provided. For the purposes of explanation, the execution of a neural network will be explained from the perspective of the second processing core. This is not meant to limit the applications of the proposed technology, but rather to provide an example.

Prior to executing a current layer of a neural network, the second processing core determines a synchronization status of the first processing core with respect to a previous layer of the network. A synchronization status is representative of a status which indicates the current execution state of a processing core for a respective layer. For example, the synchronization status of the first processing core may indicate to the second processing core that the first processing core has completed execution of the previous layer of the network. In an implementation, to check the synchronization status of the first processing core, the second processing core reads the synchronization status of the first processing core from a shared memory.

After determining the execution of the previous layer of the network is complete, both the first and second processing cores execute the current layer of the neural network based on data computed in the previous layer. In an implementation, the first and second processing cores each have a dedicated section in memory for storing output data of a layer. For example, the first processing core may store its output data of the previous layer within its dedicated section of the memory and, the second processing core may also store its output data of the previous layer within its dedicated section of the memory. Prior to executing the current layer of the network, a memory controller coupled to both processing cores performs a direct memory access (DMA) transfer on the relevant output data of the first processing core to the section in memory which is dedicated to the second processing core. The memory controller also performs a DMA transfer on the relevant output data of the second processing core to the section in memory which is dedicated to the first processing core. As a result of the DMA transfer, both the first and second processing cores have access to the necessary input data for executing the current layer of the network.

Upon executing the current layer of the network, the second processing core stores its output data for the current layer in the section of memory dedicated to the second processing core. Next, the second processing core updates the first processing core with a synchronization status which indicates the second processing core has stored its output for the current layer within its dedicated section of the memory. In an implementation, to update the first processing core with the synchronization status of the second processing core, the second processing core writes its synchronization status to the shared memory for consumption by the first processing core.

In an implementation, after both processing cores have stored their output data for the current layer within their dedicated sections of the memory and updated their respective synchronization statuses, the memory controller performs a DMA transfer on the relevant output data. It should be noted that the relevant output data describes the data produced by a processing core for a current layer, which is required as input data by the other processing core for executing the next layer of the network. For example, the relevant output data of the first processing core describes the section of output data produced by the first processing core for the current layer, which is required by the second processing core for executing the next layer of the network. As a result of the DMA transfer, both the first and second processing cores have access to the necessary input data for executing the next layer of the network. Prior to executing the next layer of the network, the first processing core updates the second processing core with a synchronization status which indicates the first processing core has completed executing the current layer of the network. Further, the second processing core updates the first processing core with a synchronization status which indicates the second processing core has completed executing the current layer of the network.

In an implementation, the first and second processing cores continue to execute the remaining layers of the network in the same fashion. Meaning, both processing cores ensure the other processing core has completed execution of a previous layer of the network, and has access to input data for executing a next layer of the network, by way of synchronization statuses. Advantageously the proposed technology increases the number of synchronization statuses for each processing core for a given layer, which in turn avoids dead-lock conditions during the execution of a neural network. As a result, the usefulness and speed of using multi-core devices for neural network execution increase. In addition, a multi-core device implementing the techniques of this disclosure may have reduced latency, as compared to other devices, and may avoid race conditions and deadlock. The techniques of this disclosure provide coordination across multiple cores and is scalable to any number of cores.

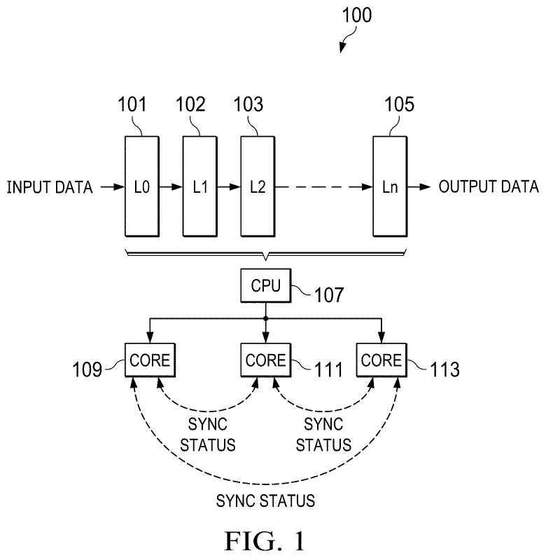

Turning now to the figures, FIG. 1 illustrates system 100 in an implementation. System 100 is representative of a multi-core system configured to synchronize the execution of a neural network across multiple processing cores. System 100 includes, but is not limited to, layers 101, 102, 103, and 105, CPU 107, and cores 109, 111, and 113.

Layers 101, 102, 103, and 105 are representative of the various layers of a neural network. For example, layers 101, 102, 103, and 105 may represent the layers of a convolutional neural network (CNN), artificial neural network (ANN), recurrent neural network (RNN), or another deep neural network (DNN) of the like. In an implementation, layer 101 is representative of an input layer, layers 102 and 103 are representative of hidden layers, and layer 105 is representative of an output layer of the network. It should be noted that the network may contain more than two hidden layers, but, for the purposes of explanation, only two hidden layers are depicted.

Prior to the deployment of the neural network, the input data to layer 101 is divided into sections and delegated to the multiple processing cores of system 100. In an implementation the number of input data sections is equal to the number of processing cores within the multi-core system. For example, in the context of system 100, the input data to layer 101 is divided into three separate input data sections and delegated to cores 109, 111, and 113.

CPU 107 is representative of one or more circuits configured to manage the execution of a neural network. For example, CPU 107 may be representative of an ARM processing core. In an implementation, CPU 107 is configured to determine which sections of input data are processed by which cores of system 100. That is, CPU 107 determines, for a given section of the input data, which one of cores 109, 111, and 113 will process the data. For example, CPU 107 may instruct core 109 to execute layer 101 with a first section of input data. Further, CPU 107 may instruct core 111 to execute layer 101 with a second section of input data and core 113 to execute layer 101 with a third section of input data. In an implementation, the first, second, and third sections of input data may be combined to generate the complete input data set for layer 101.

Cores 109, 111, and 113, are representative of processing cores configured to execute program code. For example, cores 109, 111, and 113 may be representative of digital signal processors (DSPs), GPUs, TPUs, application-specific integrated circuits (ASICs), or another device of the like configured to execute the layers of a neural network. In an implementation, cores 109, 111, and 113 are configured to synchronize the execution of layers 101, 102, 103, and 105. Meaning, cores 109, 111, and 113 ensure each processing core of system 100 is executing the same layer of the neural network at the same time.

During the execution of the neural network, cores 109, 111, and 113 update each other with synchronization statuses with respect to their current execution state. In an implementation, each processing core has two available synchronization statuses for a given layer. The first synchronization status is representative of a status that indicates a processing core has generated output data for a current layer. For example, the first synchronization status of core 109 may indicate that core 109 has generated output data for layer 101. The second synchronization status is representative of a status that indicates a core has access to input data for executing a next layer of the network. For example, the second synchronization status of core 109 indicates that the relevant output data generated by cores 111 and 113 for layer 101 is accessible to core 109 as input data for executing layer 102 of the network.

In an implementation, a processing core has completed the execution of a current layer when the processing core has access to input data for executing a next layer of the network. Meaning, a processing core has completed execution of a layer when the processing core updates its status to the second synchronization status for the layer. In an implementation, to execute a next layer of the network, each core of system 100 must indicate they have completed execution of the previous layer by way of synchronization statuses. For example, prior to executing layer 102, cores 109, 111, and 113 must update their synchronization statuses with respect to layer 101 to the second synchronization status.

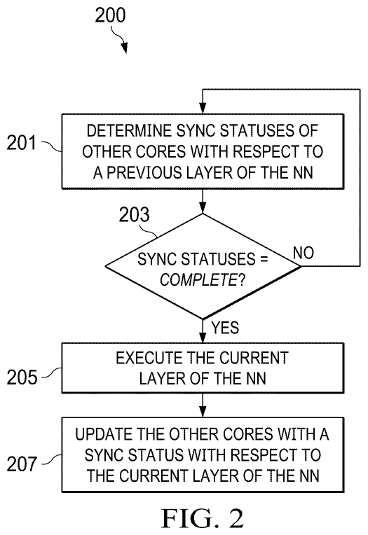

FIG. 2 illustrates synchronization method 200 in an implementation. Synchronization method 200 is representative of software for synchronizing the execution of a neural network within a multi-core system. Synchronization method 200 may be implemented in the context of program instructions that, when executed by a suitable computing system, direct the processing circuitry of the computing system to operate as follows, referring parenthetically to the steps in FIG. 2. For the purposes of explanation, synchronization method 200 will be explained with the elements of FIG. 1. More specifically, synchronization method 200 will be explained from the perspective of core 109. This is not meant to limit the applications of synchronization method 200, but rather to provide an example.

To begin, core 109 determines the synchronization statuses of cores 111 and 113 with respect to a previous layer of the network (step 201). For example, if the current layer of the network is layer 102, then core 109 determines the synchronization statuses of cores 111 and 113 with respect to layer 101. In an implementation, to check the synchronization statuses of core 111 and core 113, core 109 reads the synchronization statuses of cores 111 and 113 from a shared memory.

Next, core 109 determines if cores 111 and 113 have completed execution of layer 101 (step 203). In other words, core 109 checks the synchronization statuses of cores 111 and 113 with respect to layer 101 to determine if the synchronization statuses are set to the second synchronization status. In an implementation, a processing core updates its status to the first synchronization status when the processing core stores its output data in a section of memory dedicated to that core. The processing core may further update its status to the second synchronization status when the core has access to the necessary input data for executing the next layer of the network. For example, core 111 updates to the first synchronization status when the output data generated by core 111 for layer 101 is stored in the section of memory dedicated to core 111. Core 111 may then update its status to the second synchronization status when the relevant output data generated by cores 109 and 113 for layer 101 is accessible to core 111 as input data for executing layer 102. In an implementation, system 100 includes a memory controller configured to perform a DMA transfer on the relevant output data of each core. For example, after cores 109 and 113 update their status to the first synchronization status, the memory controller may perform a DMA transfer on the relevant output data stored in the sections of memory dedicated to cores 109 and 113 to the section in memory dedicated to core 111. As a result of the DMA transfer, core 111 has access to the necessary input data for executing layer 102 of the network and may update its status to the second synchronization status for layer 101 of the network.

Core 109 reads the synchronization statuses of cores 111 and 113 from the shared memory. If core 109 determines that cores 111 and 113 have not updated to the second synchronization status for layer 101, then core 109 rereads the synchronization statuses from the shared memory to determine if the synchronization statuses of cores 111 and 113 for layer 101 have been updated. Alternatively, if core 109 determines that cores 111 and 113 have updated their status to the second synchronization status for layer 101, then core 109 may execute layer 102 (step 205). It should be noted that core 109 waits to execute layer 102 until each core of system 100 (i.e., core 109, core 111, and core 113) has updated its status to the second synchronization status for layer 101 of the network. Once updated, core 109 utilizes the data stored in the section in memory dedicated to core 109 to execute layer 102 of the network. More specifically, to execute layer 102 of the network, core 109 utilizes the output data generated by core 109 for layer 101 of the network and utilizes the relevant sections of output data generated by cores 111 and 113 for layer 101 of the network as input data for executing layer 102.

After execution of layer 102, core 109 stores its output data in the section of memory dedicated to core 109 and updates its synchronization status to the first synchronization status (step 207). In an implementation, the memory controller performs the DMA transfer on the relevant sections of output data when core 109 updates its status to the first synchronization status. In another implementation, the memory controller performs the DMA transfer when every processing core of system 100 updates its status to the first synchronization status. In either case, after the memory controller provides the necessary input data for executing the next layer of the network to a processing core, the processing core may update its synchronization status to the second synchronization status. Once every core of system 100 has updated to the second synchronization status, each core may continue to execute layer 103.

It should be noted that during the course of operation, each processing core of system 100 executes synchronization process 200 for each layer of the network. Meaning, prior to execution of a layer, each core determines if the synchronization statuses of the other cores are set to the second synchronization status with respect to a previous layer of the network. Once determined, each processing core executes the current layer of the network based on data computed in the previous layer. After execution of the current layer each core stores its output data in its dedicated section of memory and updates its status to the first synchronization status for the current layer. Next, the memory controller performs the DMA transfer on the relevant output data sections of each core, and in response, each core updates its status to the second synchronization status for the current layer. Once each core has updated its status to the second synchronization status for the current layer of the network, each core may execute the next layer of the network.

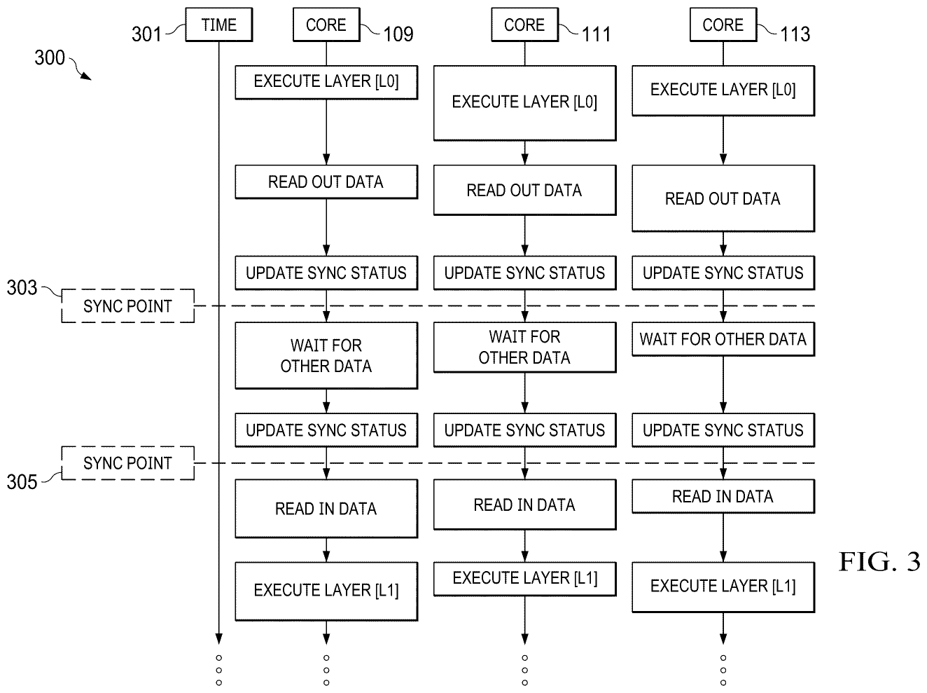

FIG. 3 illustrates an operational sequence in an implementation. Operational sequence 300 is representative of an application of synchronization method 200, performed by each processing core of system 100. Operational sequence 300 includes timeline 301, core 109, core 111, and core 113.

To begin, cores 109, 111, and 113 execute layer 101 of the network. In an implementation, to execute the input layer of a network, the input data for the layer is divided into sections for processing by a respective core. For example, the input data to layer 101 may be divided into three sections, such that core 109 executes layer 101 with a first section of input data, core 111 executes layer 101 with a second section of input data, and core 113 executes layer 101 with a third section of input data. It should be noted that the time taken to execute a layer may vary between the cores of system 100. For example, core 109 executes layer 101 the fastest, while core 111 executes layer 101 the slowest.

In an implementation, after a core finishes execution of a layer, the core may then read out the output data generated from the layer execution to a location in memory dedicated to that core. For example, after core 109 finishes executing layer 101, core 109 may then read out the output data generated from the layer execution to the location in memory dedicated to core 109. Similarly, after cores 111 and 113 finish execution of layer 101, both cores 111 and 113 may then read out the output data generated from the layer execution to the locations in memory dedicated to cores 111 and 113 respectively. In an implementation, cores 109, 111, and 113 direct a memory controller associated with system 100 to read out the output data generated for a layer to the section in memory dedicated to the respective core.

Once the output data of cores 109, 111, and 113 is stored in the respective locations in memory, cores 109, 111, and 113, may update their status for layer 101 to the first synchronization status. The first synchronization status is representative of a status which indicates a core has stored its output data for a given layer in its dedicated location in memory. For example, core 109 updates its status to the first synchronization status after core 109 stores its output data from layer 101 in the location in memory dedicated to core 109. Similarly cores 111 and 113 update their status to the first synchronization status after storing their output data for layer 101 in the locations in memory dedicated to cores 111 and 113. In an implementation, the moment in time for when each core has updated its status to the first synchronization status is defined as the first synchronization point, herein referred to as sync point 303.

After reaching sync point 303, cores 109, 111, and 113 wait idly for a memory controller associated with system 100 to perform a DMA transfer on the output data of each core. In an implementation, the memory controller performs a DMA transfer on the sections of output data which are required by the other processing cores as input data for executing the next layer of the network. For example, the memory controller may perform a DMA transfer on a section of output data generated by core 109 for layer 101 to the location in memory dedicated to core 111. As a result, the memory controller provides the necessary input data to core 111 for executing layer 102 of the network.

Once each core has access to the necessary input data for executing layer 102, each core may then update its status for layer 101 to the second synchronization status. The second synchronization status is representative of a status which indicates a core has access to the input data for executing the next layer of the network. In an implementation, the second synchronization status is further representative of a status which indicates a core has completed the execution of a previous layer. For example, if the status of core 109 is set to the second synchronization status for layer 101, then core 109 has access to the input data for executing layer 102 of the network and is considered to be done executing layer 101. In an implementation, the moment in time for when each core has updated its status for a given layer to the second synchronization status is defined as the second synchronization point, herein referred to as sync point 305.

After reaching sync point 305, cores 109, 111, and 113 acquire the input data for executing layer 102 of the network. In an implementation, to acquire the input data, cores 109, 111, and 113 read in the data stored in the dedicated sections of memory to a buffer dedicated to that core. For example, core 109 reads in the data stored in the memory location dedicated to core 109 and stores the data in a buffer of core 109. In an implementation, once a core has stored the necessary input data within its buffer, the core may then continue to execute the next layer of the network. For example, cores 109, 111, and 113 may execute layer 102 of the network when each core has finished reading in the necessary input data for executing layer 102 to its respective buffer.

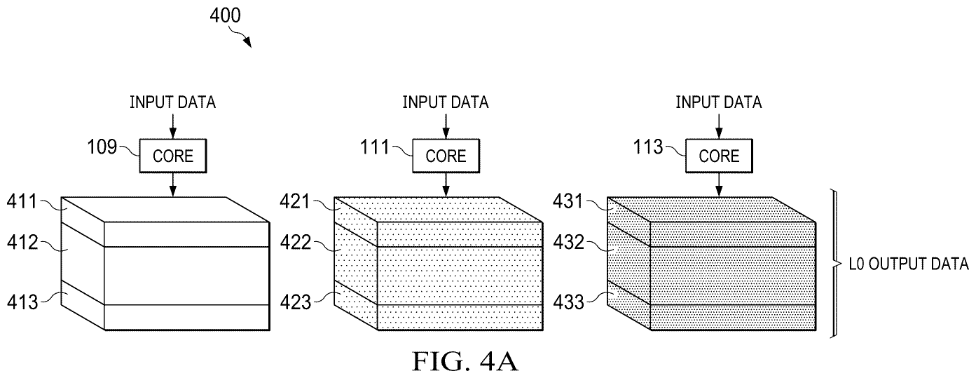

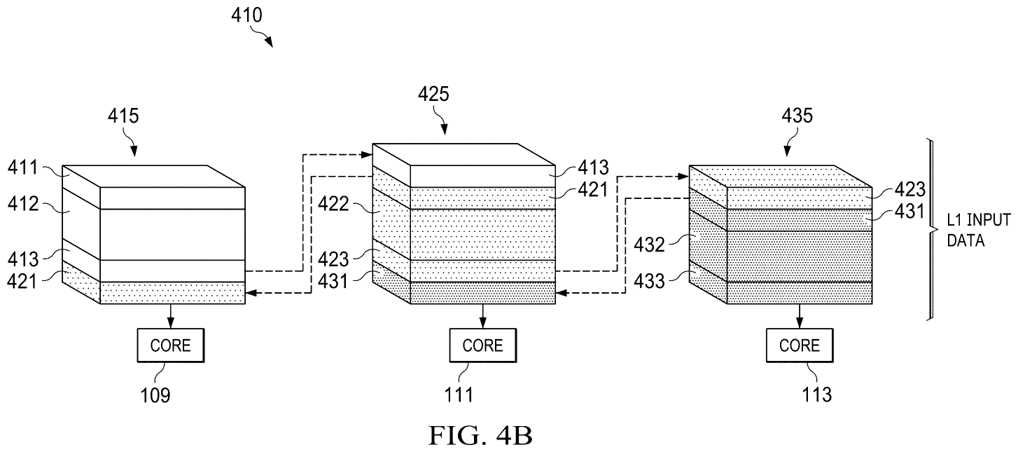

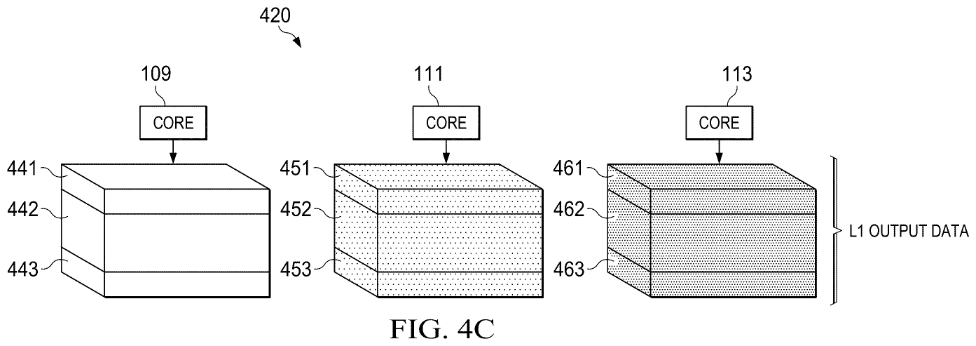

FIGS. 4A-4C illustrate an operational scenario for executing a neural network with the elements of system 100 in an implementation, such that FIG. 4A depicts a first stage of operations, FIG. 4B illustrates a second stage of operations, and FIG. 4C illustrates a third stage of operations. Turning to FIG. 4A, stage 400 illustrates a scenario for executing the input layer of a neural network across multiple processing cores. Stage 400 includes cores 109, 111, and 113, and output data sections 411-413, 421-423, and 431-433.

To begin, cores 109, 111, and 113 receive input data for executing layer 101 of the network. In an implementation, each core of system 100 receives a section of input data such that each section may be combined to generate a complete input data set. For example, in the context of computer vision applications, the complete input data set for executing layer 101 may be representative of a feature map. Prior to the execution of layer 101, the feature map is divided into three separate input data sections, such that during the course of operations, core 109 executes layer 101 with a first section of input data, core 111 executes layer 101 with a second section of input data, and core 113 executes layer 101 with a third section of input data.

After the execution of layer 101, each core of system 100 generates sections of output data. For example, core 109 generates output data sections 411, 412, and 413, core 111 generates output data sections 421, 422, and 423, and core 113 generates output data sections 431, 432, and 433. Output data sections 411-413, 421-423, and 431-433 represent the output data for layer 101 and further represent the input data for layer 102 of the network.

In an implementation, cores 109, 111, and 113, each store their output data sections in locations in memory dedicated to the respective core. For example, core 109 stores output data sections 411, 412, and 413 in a location in memory dedicated to core 109. Similarly, cores 111 and 113 respectively store output data sections 421-423 and 431-433 in locations in memory dedicated to cores 111 and 113. In an implementation, after a processing core of system 100 stores its output data in memory, the processing core may update its status to the first synchronization status for that layer. For example, after cores 109, 111, and 113 store their output data in memory, cores 109, 111, and 113 may then update their status to the first synchronization status for layer 101 of the network.

Now turning to FIG. 4B, stage 410 illustrates a first stage for executing a hidden layer of a neural network. For example, stage 410 may depict a scenario for executing layer 102 or layer 103 of the network. For the purposes of explanation, the execution of layer 102 will be discussed herein. This specification is not meant to limit the applications of the proposed technology, but rather to provide an example. As such, stage 410 includes cores 109, 111, and 113, and input data sections 415, 425, and 435.

Input data sections 415, 425, and 435 are representative of the sections of data for executing layer 102 of the network. More specifically, input data section 415 is representative of the input data for core 109, input data section 425 is representative of the input data for core 111, and input data section 435 is representative of the input data for core 113. It should be noted that input data sections 415, 425, and 435 are further representative of the output data sections generated from the execution of layer 101. For example, input data section 415 includes output data sections 411, 412, and 413, input data section 425 includes output data sections 421, 422, and 423, and input data section 435 includes output data sections 431, 432, and 433.

Prior to the execution of layer 102, each processing core of system 100 must update its status to the second synchronization status. The second synchronization status is representative of a status which indicates a core has completed execution of the previous layer of the network. In an implementation, a core has completed execution of the previous layer of the network, when the core has access to the input data for executing the next layer of the network. For example, core 109 may update its status to the second synchronization status for layer 101 when core 109 has access to output data section 421. Similarly, core 111 may update its status to the second synchronization status for layer 101 when core 111 has access to output data sections 413 and 431. Finally, core 113 may update its status to the second synchronization status for layer 101 when core 113 has access to output data section 413.

In an implementation, cores 109, 111, and 113 are coupled to a memory controller configured to perform DMA transfers of the output data sections. For example, the memory controller may perform a DMA transfer of output data section 413 to the location in memory dedicated to core 111. As a result of the DMA transfers, input data section 415 further includes output data section 421, input data section 425 further includes output data sections 413 and 431, and input data section 435 further includes output data section 423. In other words, each core of system 100 now has access to the necessary input data for executing layer 102 of the network. Meaning, each core may update its status to the second synchronization status for layer 101 of the network.

Finally turning to FIG. 4C, stage 420 illustrates the second stage for executing a hidden layer of a neural network. More specifically, stage 420 illustrates a scenario for executing layer 102 of the network. To begin, each core of system 100 ensures that the statuses of the other processing cores are set to the second synchronization status for layer 101 of the network. If set, the cores may continue to execute layer 102. Else, the cores of system 100 must wait for each core to update its status to the second synchronization status for layer 101 of the network.

After determining the statuses of each core of system 100 are set to the second synchronization status for layer 101 of the network, cores 109, 111, and 113 may execute layer 102 of the network. As a result of executing layer 102, core 109 generates output data sections 441, 442, and 443, core 111 generates output data sections 451, 452, and 453, and core 113 generates output data sections 461, 462, and 463. Output data sections 441-443, 451-453, and 461-463 represent the output data for layer 102 and further represent the input data for layer 103 of the network. In an implementation, after execution of layer 102, cores 109, 111, and 113 each store their output data in the locations in memory dedicated to them. In addition, each core may also update its status to the first synchronization status for layer 102 of the network. For example, after execution of layer 102 core 109 may store output data sections 441, 442, and 443 in the location in memory dedicated to core 109 and update its status to the first synchronization status for layer 102 of the network.

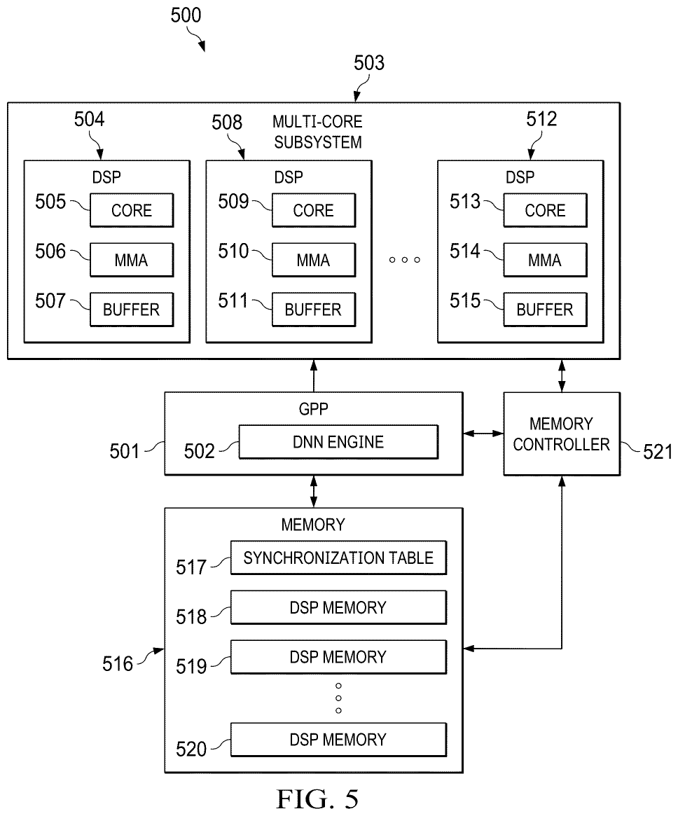

Now turning to the next figure, FIG. 5 illustrates system 500 in an implementation. System 500 is representative of a multi-core device configured to synchronize the execution of a neural network across multiple processing cores. System 500 includes general-purpose processor (GPP) 501, multi-core subsystem 503, memory 516, and memory controller 521.

GPP 501 is representative of one or more circuits configured to manage the execution of a neural network. For example, GPP 501 may be representative of a CPU (e.g., CPU 107), MCU, GPU, TPU, or another processing unit of the like. In an implementation, GPP 501 is configured to delegate sections of input data to the multiple processing cores of multi-core subsystem 503. For example, GPP 501 may receive input data for a neural network, and in response, divide the input data into a number of sections such that the number of input data sections is equal to the number of processing cores in system 500. GPP 501 includes, but is not limited to, deep neural network (DNN) engine 502.

DNN engine 502 is representative of software employed by GPP 501 to perform a designated task. For example, DNN engine 502 may be representative of a CNN, ANN, RNN, or another network of the like configured to perform image processing tasks such as classification, detection, segmentation, or other tasks of the like. DNN engine 502 comprises a series of interconnected layers including an input layer (e.g., layer 101), one or more hidden layers (e.g., layer 102 or layer 103), and an output layer (e.g., layer 105).

Multi-core subsystem 503 is representative of one or more circuits configured to execute the layers of a neural network. For example, multi-core subsystem 503 may be configured to execute the layers of DNN engine 502. Multi-core subsystem 503 includes, but is not limited to, DSP 504, DSP 508, and DSP 512.

DSPs 504, 508, and 512 represent one or more circuits configured to execute the layers of a network with sections of input data. For example, DSPs 504, 508, and 512 may execute a layer of DNN engine 502 with sections of input data, such that each section of input data may be combined to generate the complete input data set for the layer. As a result, DSPs 504, 508, and 513 produce sections of output data, such that each section of output data may be combined to generate the complete output data set for the layer. DSP 504 includes core 505, matrix multiply accelerator (MMA) 506, and buffer 507. Similarly, DSP 508 includes core 509, MMA 510, and buffer 511, and DSP 512 includes core 513, MMA 514, and buffer 515.

Cores 505, 509, and 513 are representative of processing cores (e.g., cores 109, 111, and 113) configured to synchronize the layer execution of DNN engine 502 across DSPs 504, 508, and 512. For example, cores 505, 509, and 513 may be configured to update the synchronization statuses of DSPs 504, 508, and 512 respectively. In an implementation, each DSP of multi-core subsystem 503 has at least two available synchronization statuses for a given layer of the network. The first synchronization status is representative of a status which indicates a DSP has stored its section of output data for a current layer in a memory location which is dedicated to that core. For example, core 505 may set the status of DSP 504 for the current layer to the first synchronization status (i.e., DMA_READY) when DSP 504 stores its section of output data for the current layer in DSP memory location 518. The second synchronization status is representative of a status which indicates a DSP has access to the necessary input data for executing the next layer of the network. For example, core 505 may update the status of DSP 504 from the first synchronization status to the second synchronization status (i.e., COMPLETE) when DSP memory location 518 stores the relevant sections of output data produced by DSPs 508 and 512 which are required as input data by DSP 504 for executing the next layer of the network.

MMAs 506, 510, and 514 are representative of hardware accelerators configured to perform matrix operations. For example, MMAs 506, 510, and 514 may perform multiplication operations, convolution operations, or other matrix operations of the like. During the execution of a layer, DSPs 504, 508, and 512 offload matrix operations to MMAs 506, 510, and 514 respectively. Advantageously, MMAs 506, 510, and 514 accelerate the execution of a layer, and in turn, accelerate the execution of DNN engine 502.

Buffers 507, 511, and 515 are representative of storage locations in which DSPs 504, 508, and 512 may respectively store data. For example, DSPs 504, 508, and 512 may store sections of input data in buffers 507, 511, and 515. Similarly, DSPs 504, 508, and 512 may also store sections of output data in buffers 507, 511, and 515.

Memory 516 is representative of one or more volatile or non-volatile computer-readable storage media including instructions, data, and the like (e.g., random access memory, flash memory). For example, memory 516 may store the output data for the layers of a neural network. Memory 516 includes, but is not limited to, synchronization table 517 and DSP memory locations 518, 519, and 520.

Synchronization table 517 is representative of a table, stored in memory 516, which tracks the synchronization statuses of the processing cores of multi-core subsystem 503 for each layer of DNN engine 502. In an implementation cores 505, 509, and 513 update synchronization table 517 to match the current execution state of a respective DSP for a given layer. For example, core 505 updates the status of DSP 504 to the first synchronization status (i.e., DMA_READY) when DSP 504 stores its section of output data for a current layer in DSP memory location 518. Core 505 may then update the status of DSP 504 to the second synchronization status (i.e., COMPLETE) when DSP 504 has access to the necessary input data for executing the next layer of the network. In an implementation, to update the synchronization statuses of DSPs 504, 508, and 512, cores 505, 509, and 513 instruct memory controller 521 to update synchronization table 517 to match the current state of a respective DSP for a given layer.

DSP memory locations 518, 519, and 520 are representative of locations in memory 516 for storing output data of DSPs 504, 508, and 512. More specifically, DSP memory location 518 represents a location in memory for storing data of DSP 504, DSP memory location 519 represents a location in memory for storing data of DSP 508, and DSP memory location 520 represents a location in memory for storing data of DSP 512. During the course of operations, DSPs 504, 508, and 512 send output data of a layer to memory controller 521 for storage in a respective DSP memory location. For example, DSP 504 may send its section of output data to memory controller 521 for storage in DSP memory location 518.

Memory controller 521 is representative of one or more circuits configured to manage the flow of data going to and coming from memory 516. For example, memory controller 521 may update synchronization table 517 with the current synchronization statuses of DSPs 504, 508, and 512 for a given layer. In some examples, DSPs 504, 508, and 512 may be configurable to read and write directly to the synchronization table 517, rather than accessing synchronization table 517 through memory controller 521. Memory controller 521 may further store the output data sections of DSPs 504, 508, and 512 in the respective memory locations. In an implementation, memory controller 521 is configured to perform a DMA transfer on data stored in a first DSP memory location to the remaining DSP memory locations of memory 516. For example, memory controller 521 may perform a DMA transfer on data stored in DSP memory location 518 to DSP memory locations 519 and 520.

In an implementation, memory controller 521 performs the DMA transfer when the synchronization status of a DSP is set to the first synchronization status. For example, memory controller 521 may perform a DMA transfer on the relevant section of output data generated by DSP 504 when the synchronization status of DSP 504 is set to DMA_READY. It should be noted, the relevant section of output data describes the data produced by DSP 504 for a current layer, which is required as input data by the other DSPs of multi-core subsystem 503 for executing the next layer of DNN engine 502.

In another implementation, memory controller 521 performs the DMA transfer when the synchronization status of each DSP of multi-core subsystem 503 for a given layer is set to the first synchronization status. For example, memory controller 521 may perform a DMA transfer on the relevant sections of output data when the synchronization statuses of DSPs 504, 508, and 512 are set to DMA_READY for the current layer. As a result of the DMA transfer, DSP memory locations 518, 519, and 520, each store the necessary input data for executing the next layer of the network and, DSPs 504, 508, and 512 may update their synchronization status to COMPLETE. In an implementation, prior to executing a next layer of the network, memory controller 521 routes the data stored in DSP memory locations 518, 519, and 520 to buffers 507, 511, and 515 respectively.

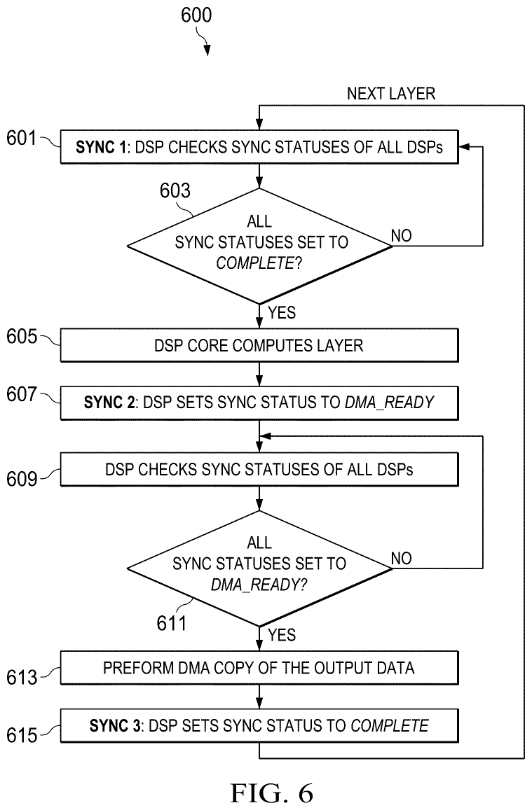

FIG. 6 illustrates synchronization process 600 in an implementation. Synchronization process 600 is representative of a process for synchronizing the execution of the layers of a neural network across multiple processing cores. For example, synchronization process 600 may be representative of synchronization method 200 of FIG. 2. Synchronization process 600 may be implemented in the context of program instructions that, when executed by a suitable computing system, direct the processing circuitry of the computing system to operate as follows, referring parenthetically to the steps in FIG. 6. For the purposes of explanation, synchronization process 600 will be explained with the elements of FIG. 5. More specifically, synchronization process 600 will be explained from the perspective of DSP 504. This is not meant to limit the applications of synchronization process 600, but rather to provide an example.

To begin, DSP 504 checks the synchronization statuses of each processing core of multi-core subsystem 503 with respect to a previous layer of the network (step 601). In an implementation, to check the synchronization statuses of the processing cores, core 505 instructs memory controller 521 to read the current synchronization statuses stored in memory 516 with respect to the previous layer of the network. When instructed, memory controller 521 routes the synchronization statuses of synchronization table 517 to core 505.

Next, DSP 504 determines if the synchronization statuses of each processing core of multi-core subsystem 500 are set to COMPLETE with respect to the previous layer of the network (step 603). In other words, core 505 determines if DSPs 504, 508, and 512 have completed execution of the previous layer of the network and have access to input data for executing the current layer of the network. If core 505 determines that any of DSPs 504, 508, and 512 have not yet updated their synchronization status to COMPLETE, then core 505 instructs memory controller 521 to reread the synchronization statuses from memory 516. In an implementation, core 505 iteratively instructs memory controller 521 to reread the statuses of synchronization table 517 until the statuses of DSPs 504, 508, and 512 with respect to the previous layer of the network are all set to COMPLETE.

Once core 505 determines the synchronization statuses of DSPs 504, 508, and 512 are set to COMPLETE, core 505 executes the current layer of the network (step 605). In an implementation, to execute the current layer of the network, core 505 instructs memory controller 521 to route input data stored in DSP memory location 518 to buffer 507. Once loaded to buffer 507, core 505 executes the current layer of the network. It should be noted that the input data used to execute the current layer of the network may be representative of output data generated from the previous layer of the network.

After execution of the current layer of the network, core 505 stores its output data for the current layer in buffer 507. Further, core 505 instructs memory controller 521 to route the output data from buffer 507 to DSP memory location 518. In an implementation, after the output data of the current layer is stored in DSP memory location 518, core 505 instructs memory controller 521 to update the synchronization status of DSP 504 to DMA_READY for the current layer of the network (step 607).

Next, core 505 instructs memory controller 521 to check the synchronization statuses of DSPs 504, 508, and 512 with respect to the current layer of the network (step 601). Core 505 receives the synchronization statuses from memory controller 521 and in response determines if the synchronization statuses of DSPs 504, 508, and 512 are each set to DMA_READY for the current layer (step 611). In an implementation, if core 505 determines that any of DSPs 504, 508, and 512 have not yet updated their synchronization status to DMA_READY for the current layer, then core 505 instructs memory controller 521 to reread the synchronization statuses from memory 516. In an implementation, core 505 iteratively instructs memory controller 521 to reread the statuses of synchronization table 517 until the statuses of DSPs 504, 508, and 512 are all set to DMA_READY for the current layer of the network.

Once core 505 determines the synchronization statuses of DSPs 504, 508, and 512 are set to DMA_READY for the current layer, core 505 instructs memory controller 521 to perform a DMA transfer on the relevant sections of output data stored in DSP memory locations 518, 519, and 520 (step 613). When instructed, memory controller 521 will perform a DMA copy of the data stored in DSP memory location 518 to DSP memory locations 519 and 520. Similarly, memory controller 521 will perform a DMA copy of the data stored in DSP memory location 519 to DSP memory locations 518 and 520. Memory controller 521 will also perform a DMA copy of the data stored in DSP memory location 520 to DSP memory locations 518 and 519. In an implementation, memory controller 521 performs the DMA copy on the sections of data which are required by the other processing cores for executing the next layer of the network. In another implementation memory controller 521 performs the DMA copy on the entire data set stored by a DSP memory location.

After memory controller 521 performs the DMA transfer of the data, core 505 instructs memory controller 521 to update the synchronization status of DSP 504 to COMPLETE for the current layer of the network (step 615). Next, core 505 begins iteratively checking the synchronization statuses of the other cores to determine when the synchronization statuses of DSPs 504, 508, and 512 are all set to COMPLETE for the current layer of the network (steps 601 and 603). After the synchronization statuses of DSPs 504, 508, and 512 are set to complete, DSPs 504, 508, and 512 may continue to execute the next layer of the network.

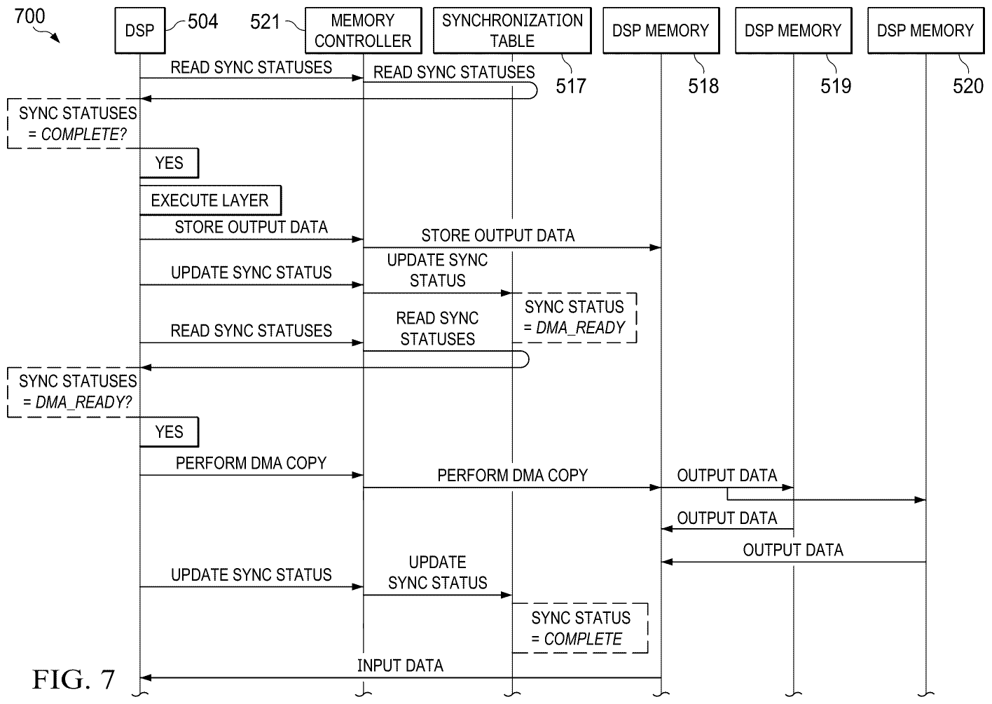

FIG. 7 illustrates operational scenario 700 in an implementation. Operational scenario 700 is representative of a scenario for synchronizing the layer execution of a neural network with respect to the elements of system 500. More specifically, operational scenario 700 is representative of a scenario for executing synchronization process 600 from the perspective of DSP 504. As such, operational scenario 700 includes DSP 504, memory controller 521, synchronization table 517, and DSP memory locations 518, 519, and 520.

To begin, core 505 checks the synchronization statuses of DSPs 504, 508 and 512 with respect to a previous layer of the network. To check the synchronization statuses of DSPs 504, 508 and 512, core 505 instructs memory controller 521 to read out the synchronization statuses for the previous layer of the network from synchronization table 517 and provide the statuses to core 505. Core 505 interprets the synchronization statuses of DSPs 504, 508, and 512 to determine if the synchronization statuses are set to COMPLETE for the previous layer of the network.

After determining the synchronization statuses are set to COMPLETE, DSP 504 executes the current layer of the network with input data stored in buffer 507. During the execution of the network, core 505 offloads matrix operations of the current layer to MMA 506. Once executed, core 505 stores its output data in buffer 507.

Next, core 505 instructs memory controller 521 to store the output data of buffer 507 in DSP memory location 518. Once stored, core 505 instructs memory controller 521 to update the synchronization status of DSP 504 to DMA_READY for the current layer of the network. After the synchronization status of DSP 504 is updated, core 505 instructs memory controller 521 to read out the synchronization statuses from synchronization table 517 to determine if the synchronization statuses of DSPs 504, 508, and 512 are each set to DMA_READY for the current layer of the network.

After core 505 determines the synchronization statuses with respect to the current layer are all set to DMA_READY, core 505 instructs memory controller 521 to perform a DMA transfer on the relevant data stored in DSP memory locations 518, 519, and 520. To perform the DMA transfer, memory controller 521 copies the relevant data of a first DSP memory location and stores the copied data in the remaining DSP memory locations. For example, memory controller 521 will copy the relevant data of DSP memory location 518 and store the copied data in DSP memory locations 519 and 520. Similarly, memory controller 521 will also copy the relevant data of DSP memory locations 519 and 520 and store the copied data in DSP memory location 518. After execution of the DMA transfer, core 505 instructs memory controller 521 to update the synchronization status of DSP 504 to COMPLETE with respect to the current layer of the network. In an implementation, once the synchronization statuses of each DSP are set to COMPLETE, memory controller 521 routes the data of DSP memory location 518 to buffer 507 to provide input data for executing the next layer of the network.

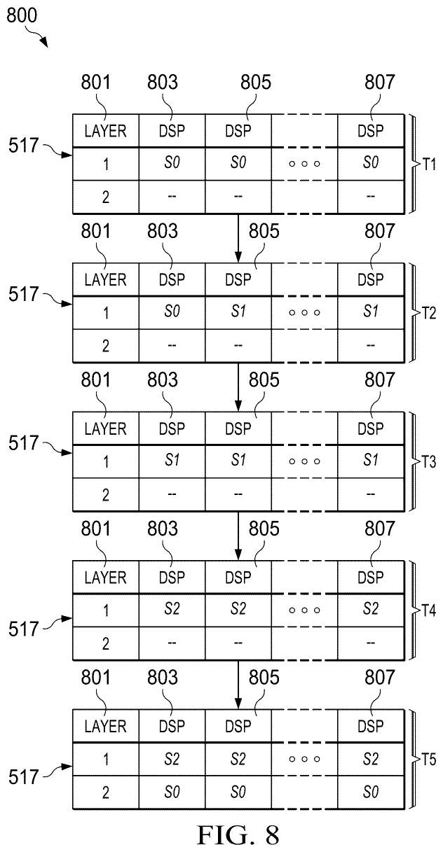

FIG. 8 illustrates operational scenario 800 in an implementation. Operational scenario 800 is representative of a scenario for updating synchronization table 517 during the execution of DNN engine 502. Operational scenario 800 includes synchronization table 517 depicted at different points in time. Synchronization table 517 includes layer column 801, DSP column 803, DSP column 805, and DSP column 807.

Layer column 801 is representative of a column which tracks the layer execution of DNN engine 502. DSP columns 803, 805, and 807 are representative of columns which track the synchronization statuses of the processing cores of multi-core subsystem 503. More specifically, DSP column 803 tracks the synchronization status of DSP 504, DSP column 805 tracks the synchronization status of DSP 508, and DSP column 807 tracks the synchronization status of DSP 512.

In an implementation, DSPs 504, 508, and 512 have three available synchronization statuses for a given layer. The first synchronization status, herein referred to as S0, is representative of a default status which indicates a DSP is ready to execute a layer of the network. The first synchronization status may be referred to as RESET because a DSP will enter the first synchronization status after a reset. The second synchronization status, herein referred to as S1, is representative of the DMA_READY status discussed above. The third synchronization status, herein referred to as S2, is representative of the COMPLETE status discussed above.

In a first stage of operations, DSPs 504, 508, and 512 are initialized to begin executing the input layer (i.e., Layer 1) of DNN engine 502. As such, DSP columns 803, 805, and 807 store the S0 status for the input layer of the network. In an implementation, to update the synchronization statuses of DSPs 504, 508, and 512, cores 505, 509, and 512 update synchronization table 517 to match the current status of a respective DSP. In another implementation, cores 505, 509, and 513 instruct memory controller 521 to update the synchronization status of the respective DSP.

In a second stage of operations, DSP 504 continues to execute the input layer of DNN engine 502, while DSPs 508 and 512 store their output data for the input layer in DSP memory locations 519 and 520 respectively. As such, DSP column 803 still stores the S0 status, while DSP columns 805 and 807 now store the S1 status for the input layer of the network. In an implementation, after execution of the input layer, cores 509 and 513 instruct memory controller 521 to route the output data for the input layer from buffers 511 and 515 to DSP memory locations 519 and 520 respectively. As a result of the data transfer, DSPs 508 and 512 may update their synchronization status to S1 for the input layer of the network.

In a third stage of operations, DSP 504 finishes executing the input layer of DNN engine 502 and stores its output data for the input layer in DSP memory location 518. As such, DSP column 803 now stores the S1 status for the input layer of the network. In an implementation, a DSP's synchronization status remains as the S1 status for a given layer until the synchronization statuses of each DSP of multi-core subsystem 503 has been updated to the S1 status. For example, the synchronization statuses of DSPs 508 and 512 remain as S/until DSP 504 updates its synchronization status to S1.

In a fourth stage of operations, memory controller 521 performs a DMA transfer on the data stored in DSP memory locations 518, 519, and 520 to provide input data to DSPs 504, 508, and 512 for executing the second layer of DNN engine 502. As such, DSP columns 803, 805, and 807 now store the S2 status for the input layer of the network. In an implementation, to perform the DMA transfer, memory controller 521 copies the output data from a first DSP memory location and stores the copied data in the remaining DSP memory locations. For example, memory controller 521 will copy the output data stored in DSP memory location 518 and will store the copied output data in DSP memory locations 519 and 520. In an implementation, memory controller 521 only copies relevant portions of the output data. In another implementation, memory controller 521 copies the entire output data set. After performing the DMA transfer, memory controller 521 routes the data of DSP memory locations 518, 519, and 520, to buffers 507, 511, and 515 respectively, to provide input data for executing the next layer of the network.

In a fifth stage of operations, DSPs 504, 508, and 512 reinitialize and begin executing the second layer (i.e., Layer 2) of DNN engine 502. As such, DSP columns 803, 805, and 807 store the S0 status for layer 2 of the network. In an implementation, a DSP will not execute the next layer of the network until the synchronization statuses of each DSP of multi-core subsystem 503 have been updated to the S2 status for the previous layer of the network. For example, DSPs 504, 508, and 512 will not execute layer 2 of DNN engine 502, until the synchronization statuses of DSPs 504, 508, and 512 are updated to S2 for the input layer of the network.

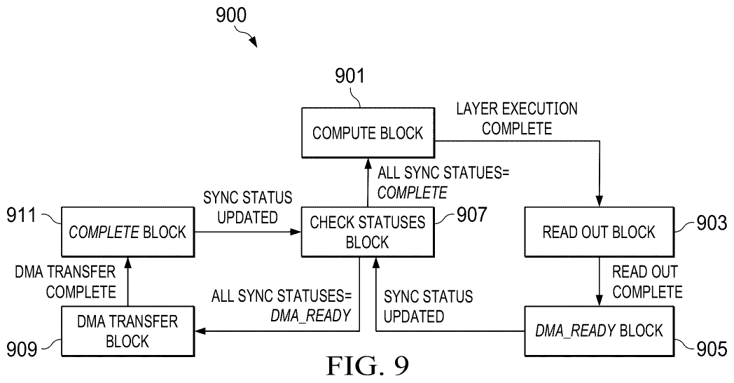

Now turning to the next figure, FIG. 9 illustrates software block diagram 900 in an implementation. Software block diagram 900 is representative of an exemplary software architecture for synchronizing the execution of a neural network across multiple processing cores. For example, software block diagram may be representative of the software architecture for synchronization method 200 or synchronization process 600. Software block diagram 900 may be implemented in the context of program instructions, executable by a suitable computing system. For example, such computing systems may include microcontrollers, application specific integrated circuits, field-programmable gate arrays, DSPs, CPUs, GPUs, and/or any other processing resources. Software block diagram 900 includes, but is not limited to, compute block 901, read out block 903, DMA_READY block 905, check statuses block 907, DMA transfer block 909, and COMPLETE block 911.

Compute block 901 is representative of logic for executing the layers of a neural network. For example, in the context of FIG. 5, compute block 901 is representative of logic, executed by cores 505, 509, and 513, for executing the layers of DNN engine 502. In an implementation, a core receives input data for executing a layer of a network, and in response executes compute block 901 to produce output data for the layer. For example, core 505 may execute compute block 901 to produce output data for an input layer of DNN engine 502.

Read out block 903 is representative of logic, executed after compute block 901, for reading out the output data of a processing core to a location in memory dedicated to that processing core. For example, after core 505 produces output data for a layer of DNN engine 502, core 505 may execute read out block 903 to cause memory controller 521 to route the output data currently stored in buffer 507 to DSP memory location 518.

DMA_READY block 905 is representative of logic, executed after read out block 903, for updating the synchronization status of a respective processing core. For example, after memory controller 521 stores the output data for core 505 in DSP memory location 518, core 505 may execute DMA_READY block 905 to update its synchronization status to DMA_READY.

Check statuses block 907 is representative of logic, executed by a processing core, for checking the synchronization statuses of the other processing cores of the multi-core system. For example, after core 505 updates the synchronization status of DSP 504 to DMA_READY, core 505 may execute check statuses block 907 to determine the synchronization statuses of DSPs 508 and 512 for the current layer of the network. In an implementation, core 505 iteratively executes check statuses block 907 until the synchronization statuses of DSPs 504, 508, and 512 are all updated to DMA_READY for the current layer of the network.

DMA transfer block 909 is representative of logic for performing a DMA transfer on the relevant sections of output data generated by a core for a current layer of the network from one section of the memory to another section of the memory. For example, cores 505 may execute DMA transfer block 909 to cause memory controller 521 to perform a DMA transfer on the relevant output data stored in DSP memory location 518 to DSP memory locations 519 and 520. In an implementation, cores 505, 509, and 513 execute DMA transfer block 909 after each core has updated its synchronization status to DMA_READY for the current layer. As a result of the DMA transfer, DSP memory locations 518, 519, and 520 store the input data for executing the next layer of the network

COMPLETE block 911 is representative of logic, executed after DMA transfer block 909, for updating the synchronization status of a respective processing core. For example, after memory controller 521 provides input data for the next layer of the network to DSP memory locations 518, core 505 may execute COMPLETE block 911 to update its synchronization status to COMPLETE. After updating its status to COMPLETE, core 505 may execute check statuses block 907 to determine if the synchronization statuses of DSPs 508 and 512 are also set to COMPLETE. In an implementation, core 505 iteratively executes check statuses block 907 until the synchronization statuses of DSPs 504, 508, and 512 are all updated to COMPLETE. Once every synchronization status has been updated to COMPLETE for the current layer of the network, memory controller 521 routes the input data stored in DSP memory locations 518, 519 and 520 to buffers 507, 511, and 515 respectively, and cores 505, 509, and 513 execute compute block 901 for the next layer of the network.

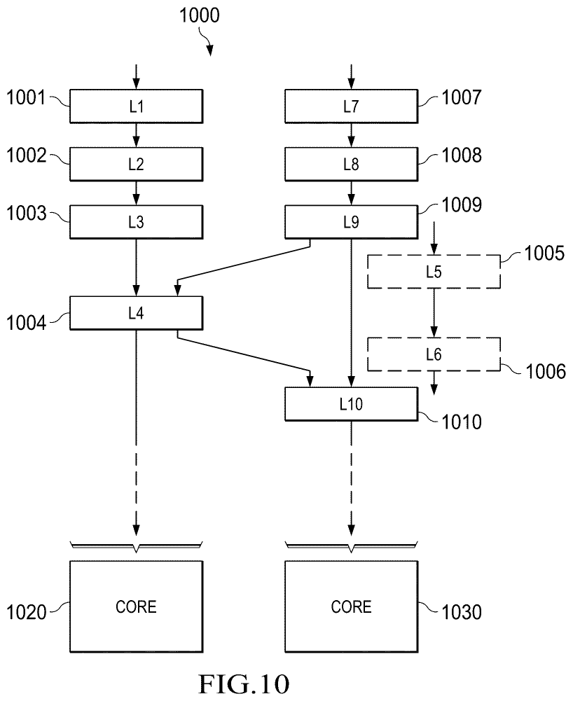

While the foregoing embodiments relate generally to scenarios where the execution of a given layer of a neural network is distributed and synchronized across multiple cores, it may be appreciated that the concepts apply as well to branched neural network layers and the synchronization therebetween. FIG. 10 illustrates one such operational example 1000 in an implementation. Operational example 1000 includes layers 1001-1010, core 1020, and core 1030.

Layers 1001, 1002, 1003, 1004, 1005, 1006, 1007, 1008, 1009, and 1010 are representative of the various layers of a branched neural network. For example, layers 1001-1010 may represent the layers of a branched CNN, ANN, RNN, or another branched DNN of the like. In an implementation layer 1001 is representative of an input layer while layers 1002-1010 are representative of the various hidden layers of the branched network. It should be noted that the network may contain more hidden layers than what has been illustrated, and further contains an output layer, but for the purposes of explanation, only layers 1002-1010 are depicted.

During the course of operations, various layers of the branched network require data produced from a previous layer of the network, such that a previous layer of the network describes a layer which outputs data which is needed by the current layer for execution. For example, to execute layer 1004, core 1020 requires data generated from the execution of layer 1003 and layer 1009. Similarly, to execute layer 1010, core 1030 requires data generated from the execution of layer 1004 and layer 1009.

Cores 1020 and 1030 are representative of processing cores (e.g., cores 109, 111, 113, 505, 509, and 513) configured to execute program code. For example, cores 1020 and 1030 may be representative of DSPs, GPUs, TPUs, ASICs, or other devices of the like configured to execute the layers of a branched neural network. In an implementation, cores 1020 and 1030, are further configured to synchronize the execution of layers 1001-1010. Meaning, core 1020 ensures core 1030 is synchronously executing layers 1005-1010 as core 1020 executes layers 1001-1004. Similarly, core 1030 ensures core 1020 is synchronously executing layers 1001-1004 as core 1020 executes layers 1005-1010.

In operation, cores 1020 and 1030 update each other with synchronization statuses with respect to the current layer in which they are executing. In an implementation, cores 1020 and 1030 have two available synchronization statuses for a given layer. The first synchronization status is representative of a status which indicates a core has generated output data for a layer. The second synchronization status is representative of a status which indicates a core has access to the necessary input data for executing the next layer of the network. In an implementation, a processing core has completed execution of a given layer when it updates its synchronization status for that layer to the second synchronization status.

In a brief operational example, core 1020 executes layer 1003 of the branched network while core 1030 executes layer 1009 of the branched network. After execution of the respective layer, core 1020 stores its output data for layer 1003 in a section of memory dedicated to core 1020, and core 1030 stores its output data for layer 1009 in a section of memory dedicated to core 1030. Once stored, cores 1020 and 1030 update their synchronization statuses for the respective layer to the first synchronization status.

Next, cores 1020 and 1030 determine if they have access to the necessary input data for executing the next layer of the network. For example, after execution of layer 1003, core 1020 determines if it has access to the necessary input data for executing layer 1004, such that the necessary input data includes data produced from the execution of layer 1003 and data produced from the execution of layer 1009. Currently, core 1020 has access to the data stored in the section of memory dedicated to core 1020 but does not have access to the data stored in the section of memory dedicated to core 1030. As such, core 1020 does not have access to the necessary input data for executing layer 1004 of the network.

In an implementation, cores 1020 and 1030 are coupled to a memory controller (e.g., memory controller 521) configured to perform DMA transfers on data stored in a first memory location to a second memory location. For example, the memory controller may perform a DMA transfer on the relevant output data generated from the execution of layer 1009 to the memory location dedicated to core 1020. As a result, core 1020 has access to the necessary input data for executing layer 1004 of the network, and in turn, may update its status for layer 1003 to the second synchronization status and begin execution of layer 1004.

As core 1020 executes layer 1004, core 1030 determines if it has access to the necessary input data for executing layer 1010, such that the necessary input data includes data produced from the execution of layer 1004 and data produced from the execution of layer 1009. Currently, layer 1004 is being executed. As such, core 1030 does not have access to the necessary input data for executing layer 1010 of the branched network, and instead executes layers 1005 and 1006. During the execution of layers 1005, and 1006, core 1030 observes the synchronization status of core 1020 with respect to layer 1004 to determine if the necessary input data for executing layer 1010 has been generated.

After execution of layer 1004, core 1020 stores its output data for layer 1004 in the section of memory dedicated to core 1020 and updates its status to the first synchronization status. Next, the memory controller performs a DMA transfer on the relevant output data generated from the execution of layer 1004 and provides the data to the section in memory dedicated to core 1030. As a result, core 1030 has access to the necessary input data for executing layer 1010 of the network, and in turn, may update its status for layer 1009 to the second synchronization status and begin execution of layer 1010.

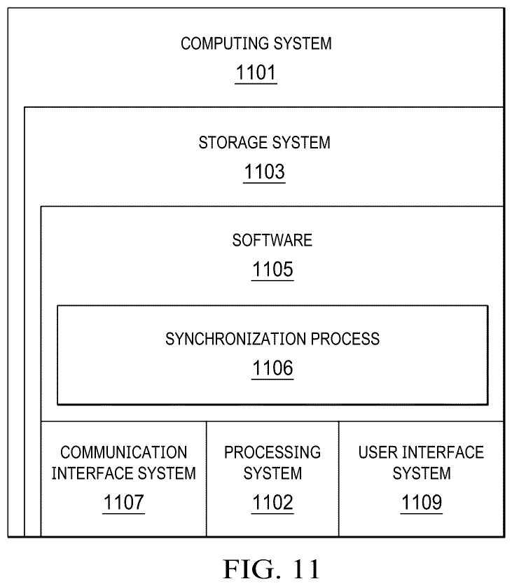

FIG. 11 illustrates computing system 1101 that represents any system or collection of systems in which the various processes, programs, services, and scenarios disclosed herein may be implemented. Computing system 1101 may be implemented as a single apparatus, system, or device or may be implemented in a distributed manner as multiple apparatuses, systems, or devices. Computing system 1101 includes, but is not limited to, processing system 1102, storage system 1103, software 1105, communication interface system 1107, and user interface system 1109 (optional). Processing system 1102 is operatively coupled with storage system 1103, communication interface system 1107, and user interface system 1109.

Processing system 1102 loads and executes software 1105 from storage system 1103. Software 1105 includes and implements synchronization process 1106, which is representative of the processes discussed with respect to the preceding Figures, such as synchronization method 200 and synchronization process 600. When executed by processing system 1102, software 1105 directs processing system 1102 to operate as described herein for at least the various processes, operational scenarios, and sequences discussed in the foregoing implementations. Computing system 1101 may optionally include additional devices, features, or functionality not discussed for purposes of brevity.

Referring still to FIG. 11, processing system 1102 comprises a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, digital signal processors (DSPs), graphical processing units, application specific processors, and logic devices, as well as any other type of processing device, combinations, or variations thereof.

Storage system 1103 comprises any computer readable storage media readable by processing system 1102 and capable of storing software 1105. Storage system 1103 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 (including synchronization process 1106) may be implemented in program instructions and among other functions may, when executed by processing system 1102, direct processing system 1102 to operate as described with respect to the various operational scenarios, sequences, and processes illustrated herein. For example, software 1105 may include program instructions for implementing processes as described herein for synchronizing the execution of a neural network within a multi-core system. The computing system 1101 may be coupled to one or more sensors and configured to receive input from the one or more sensors (e.g., a camera, radar, lidar, microphone, etc.). The sensor input(s) may form the basis for the input data in synchronization process 1106.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also comprise firmware or some other form of machine-readable processing instructions executable by processing system 1102.

In general, software 1105 may, when loaded into processing system 1102 and executed, transform a suitable apparatus, system, or device (of which computing system 1101 is representative) overall from a general-purpose computing system into a special-purpose computing system customized to support the execution of inference models in an optimized manner. Software 1105 on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary storage, as well as other factors.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, language/text, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A system comprising:
a first processing core; and
a second processing core coupled to the first processing core and configurable to:
prior to executing a current layer of a neural network, determine a synchronization status of the first processing core with respect to a previous layer of the neural network;
execute the current layer of the neural network based on data from the previous layer computed by the first processing core and by the second processing core; and
upon executing the current layer of the neural network, update the first processing core with a synchronization status of the second processing core with respect to the current layer of the neural network.

2. The system of claim 1,
wherein the data computed by the first processing core corresponds to a first section of an input tensor associated with the first processing core; and
wherein the data computed by the second processing core corresponds to a second section of the input tensor associated with the second processing core.

3. The system of claim 2 wherein the first section of the input tensor comprises a non-overlapping section of the input tensor with respect to the second section of the input tensor.

4. The system of claim 1,
wherein the first processing core is configurable to write the synchronization status of the first processing core to shared memory, and
wherein the second processing core, to determine the synchronization status of the first processing core, is configurable to read the synchronization status of the first processing core from the shared memory.

5. The system of claim 4 wherein the second processing core, to update the first processing core with the synchronization status of the second processing core, is configurable to write the synchronization status of the second processing core to the shared memory for consumption by the first processing core.

6. The system of claim 5 wherein each respective instance of the synchronization status of the first processing core indicates that the first processing core has completed executing the previous layer of the neural network.

7. The system of claim 6 wherein each respective instance of the synchronization status of the second processing core indicates that the second processing core has completed executing the current layer of the neural network.

8. Processing circuitry comprising:
first circuitry configurable to:
prior to executing a current layer of a neural network, determine a synchronization status of other processing circuitry with respect to a previous layer of the neural network; and
upon executing the current layer of the neural network, update the other processing circuitry with a synchronization status of the processing circuitry with respect to the current layer of the neural network; and
second circuitry configurable to execute the current layer of the neural network based on data from the previous layer computed by the second circuitry and other data from the previous layer computed by the other processing circuitry.

9. The processing circuitry of claim 8 wherein the data computed by the second circuitry, with respect to the previous layer of the neural network, corresponds to a section of an input tensor associated with the processing circuitry, and wherein the other data computed by the other processing circuitry corresponds to one or more other sections of the input tensor associated with the other processing circuitry.

10. The processing circuitry of claim 9 wherein the section of the input tensor and the one or more other sections of the input tensor each comprise a non-overlapping section of the input tensor with respect to each other section of the input tensor.

11. The processing circuitry of claim 8 wherein the other processing circuitry writes the synchronization status of the other processing circuitry to shared memory, and wherein the first circuitry, to determine the synchronization status of the other processing circuitry, reads the synchronization status of the other processing circuitry from the shared memory.

12. The processing circuitry of claim 11 wherein the first circuitry, to update the other processing circuitry with the synchronization status of the processing circuitry, writes the synchronization status of the processing circuitry to the shared memory for consumption by the other processing circuitry.

13. The processing circuitry of claim 8 wherein the synchronization status of the other processing circuitry status indicates to the first circuitry that the other processing circuitry has completed executing the previous layer of the neural network.

14. The processing circuitry of claim 8 wherein the synchronization status of the processing circuitry indicates to the other processing circuitry that the second circuitry has completed executing the current layer of the neural network.

15. A system, comprising;
multiple processing cores; and
a memory having a shared portion accessible to the multiple processing cores;
wherein each of the multiple processing cores is configurable to:
prior to executing a current layer of a neural network:
read, from the shared portion of the memory, a synchronization status of each of one or more other processing cores with respect to a previous layer of the neural network; and
determine, based on the synchronization status of each of the one or more other processing cores, that the one or more processing cores have completed processing with respect to the previous layer of the neural network;
execute the current layer of the neural network based on data from the previous layer computed by the processing core and other data from the previous layer computed by the one or more other processing cores; and
upon executing the current layer of the neural network, write a synchronization status of the processing core to the shared portion of the memory, wherein the synchronization status of the processing core indicates that the processing core has completed processing with respect to the current layer of the neural network.

16. The system of claim 15 wherein the memory includes non-shared portions corresponding to the multiple processing cores, and wherein the system further comprises a memory controller configurable to perform a direct memory access (DMA) transfer of the other data from one or more portions of the non-shared portions of the memory, corresponding to the one or more other processing cores, to a portion of the non-shared portions of the memory corresponding to the processing core.

17. The system of claim 16 wherein the data computed by the processing core corresponds to a section of an input tensor associated with the processing core.

18. The system of claim 17 wherein the other data computed by the one or more other processing cores corresponds to one or more other sections of the input tensor associated with the one or more other processing cores.

19. The system of claim 18 wherein the section of the input tensor and the one or more other sections of the input tensor each comprise a section of the input tensor that is non-overlapping with respect to each other section of the input tensor.

20. The system of claim 15 further comprising a general-purpose central processing unit configurable to distribute execution of the neural network to the multiple processing cores, and wherein each of the multiple processing cores comprises a digital signal processor (DSP).
